(19) United States
(12) Patent Application Publication
(10) Pub. No.: US 2008/0033846 A1
(43) Pub. Date: Feb. 7, 2008

(54) Audited Builds as an Extension to Build Tools

(75) Inventors: Steven T. Rehrauer, Princeton, MA (US); Zhenhua Shen, Boxborough, MA (US)

Correspondence Address: CUENOT & FORSYTHE, L.L.C., 12230 FOREST HILL BLVD., STE. 120, WELLINGTON, FL, 33414, US

(73) Assignee: INTERNATIONAL BUSINESS MACHINES CORPORATION, Armonk, NY (US)

(21) Appl. No.: 11/462,121

(22) Filed: Aug. 3, 2006

(51) Int. Cl. G06Q 10/00

(52) U.S. Cl. 705/28

(57) ABSTRACT

A method of auditing a build process can include invoking an audit function from a build tool, wherein the audit function is from a software configuration management (SCM) system, and collecting audit information for files having locations resolved to a data repository managed by the SCM system during a build process implemented by the build tool. The method also can include terminating the audit function from the build tool and generating a bill of materials for the build process according to the audit information.

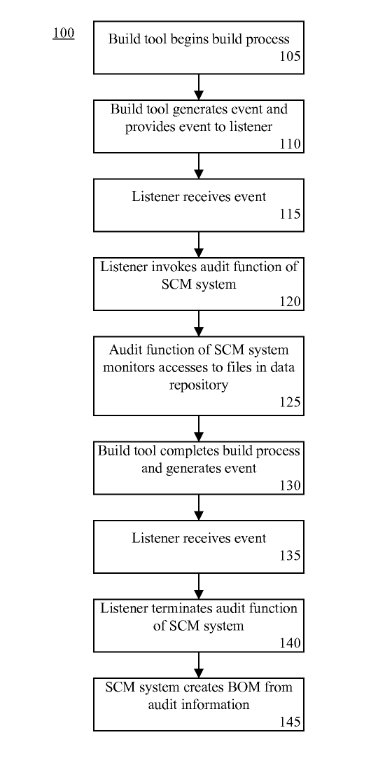

### BACKGROUND

1. Field of the Invention

The present invention relates to software development and, more particularly, to auditing builds of software systems.

2. Description of the Related Art

The development of a modern software system typically requires a significant amount of effort on the part of developers, engineers, and/or computer scientists. Throughout the development process, source code files and other software assets needed to create the software system continually evolve. It is not unusual for more than one developer, for example, to work on the same file, or set of files, concurrently. These different versions of the various software assets needed to create the software system must be tracked throughout the development process, as well as the lifecycle of the software system in order to support continued development of that system into the future.

Development efforts usually are tracked using a software configuration management (SCM) system. An SCM system provides functions relating to management and control of software development assets. For example, an SCM system can provide functions including, but not limited to, version control, automated workspace management, parallel development support, baseline management, and build and release management. One example of an SCM system is Rational® ClearCase®, which is available from International Business Machines Corporation of Armonk, N.Y.

In addition to the functions noted above, ClearCase® can generate a bill of materials (BOM) for a build process, whether an entire build or a unit, or portion, of a build for a software system. In general, ClearCase® can monitor accesses to files that are maintained within a data repository, called the Versioned Object Base (VOB), which is managed by ClearCase®. Records of the file accesses that occur during the build process are stored as an audit trail. This audit trail can be used to generate the BOM for the build process of the software system under development.

The BOM for a particular build of a software system provides a significant amount of information regarding the software assets used or accessed during the build. The BOM, for example, can indicate which source files were read during the build as well as which files were generated during the build. Other information also can be stored as part of the BOM. This information can specify attributes of the build such as which version of a particular software asset, whether a source file or a compiler, was used for the build. In general, the BOM can specify any information, whether files, settings for tools, commands, or the like, that may be required to reproduce the build with which the BOM is associated.

As noted, the BOM provides a significant amount of information which can be used for a variety of different purposes. In addition to being used to recreate a prior build, the BOM can be used to make future “build avoidance” decisions. Since the BOM indicates dependencies among different versions of the source files used to create a given build, the BOM can be used to determine which portions of a build must be performed again when one or more software assets, i.e. source files, have changed. For instance, it may be the case that a change to a single source file requires only that select portions of the software system be rebuilt rather than the entire software system. In that case, only those select portions of the software system which are dependent upon the modified source files need to be re-processed since unaffected objects generated from a prior build can be reused in creating the software system.

Several different build tools have become popular in the development community. In general, a software build tool refers to a computer program that can assemble other software. Computer program assembly can be decomposed into a sequence of “build units”, to be assembled in a specified order. Each build unit can be described as an action to be performed upon one or more input files, which may produce one or more output files. The build tool can perform build actions on each build unit, assembling build units in proper order, until the final software assembly has been completed.

In any case, one such build tool is called “Ant”. Ant is a cross-platform, Java-based build tool. While Ant provides many useful functions, Ant is unable to seamlessly integrate with existing SCM systems. In particular, a build tool such as Ant cannot audit files managed by an SCM system such as ClearCase®. This means that such a build tool is unable to create a BOM for a given build, or portion of a build, where the files are managed by an SCM system.

### SUMMARY OF THE INVENTION

The present invention relates to auditing a build process implemented by a build tool. One embodiment of the present invention can include a method of auditing a build process. The method can include invoking an audit function from a build tool, wherein the audit function is from a software configuration management (SCM) system. Audit information for files having locations resolved to a data repository managed by the SCM system can be collected during a build process implemented by the build tool. The method also can include terminating the audit function from the build tool and generating a bill of materials for the build process according to the audit information.

Another embodiment of the present invention can include a method of auditing a build process including engaging an audit function of an SCM system responsive to a request from a listener of the build tool. The build tool can implement a build process for a software system. The method also can include monitoring accesses to files having a location resolved to a data repository managed by the SCM system while the audit function is engaged and storing records corresponding to the accesses to the files having a location resolved to the data repository managed by the SCM system. The audit function can be disengaged responsive to a request from a listener of the build tool.

Yet another embodiment of the present invention can include a machine readable storage being programmed to cause a machine to perform the various steps and/or functions described herein.

### BRIEF DESCRIPTION OF THE DRAWINGS

Presently preferred embodiments are shown in the drawings. It should be appreciated, however, that the invention is not limited to the precise arrangements and instrumentalities shown.

The FIGURE is a flow chart illustrating a method of auditing a build process in accordance with one embodiment of the present invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

The embodiments disclosed herein relate to software development and to auditing a build process implemented by a build tool. In accordance with the inventive arrangements disclosed herein, a build tool can invoke an audit function of a software configuration management (SCM) system. Once invoked, accesses to files stored in a data repository managed by the SCM system by the build tool can be monitored. The audit information generated by the SCM system relating to the build process implemented by the build tool can be processed into a bill of materials (BOM) for the build.

In accordance with the inventive arrangements disclosed herein, the build tool can be configured to generate build events as build processing is performed. The build events can be provided to one or more listener objects, which can be attached to the build tool. The listener objects can be coded by developers to perform one or more functions, including calling other programs or functions.

In one embodiment, for example, the build tool can be implemented using Ant. Ant is a cross platform, open source, Java-based build tool that uses Extensible Markup Language (XML) buildfiles. Ant is extensible in a number of ways, one being that listener objects, called BuildListener objects, can be used to “hook” into the build process. For example, a listener object attached to Ant can receive events types including, but not limited to, build started, build finished, target started, target finished, task started, task finished, and message logged. Each buildfile for Ant contains one project and at least one target. A target refers to a set of tasks that the developer wishes to be executed. A task refers to a portion of code that can be executed.

The FIGURE is a flow chart illustrating a method 100 of auditing a build process in accordance with one embodiment of the present invention. The method 100 can begin in a state where a build tool has been configured with one or more listeners. The listeners can be configured to communicate with, or implement, one or more functions of an SCM system responsive to receiving selected events from the build tool during a build process. The build tool can be used, or invoked, by a developer to build a software system or a portion of the software system.

In step 105, the build tool can begin a build process. As used herein, a build process, or a unit of a build or build unit, can refer to an entire build or any portion thereof. In one embodiment, for example, a unit of a build can be any subdivision of a build that has been defined by a developer, i.e. a user of the build tool. That is, the user can invoke the build tool to create any portion, or all, of a software system under development, as may be defined by a buildfile, for example.

In step 110, the build tool can generate an event corresponding to the start of the build process and provide that event to a listener. The event indicating the start of a build process within the build tool can be provided to a listener object that has been registered to receive such events and that has been attached to the build tool. In step 115, the listener can receive the event indicating the start of the build process.

In step 120, the listener, responsive to receiving the event, can invoke an audit function of an SCM system. In one embodiment, the SCM system can be implemented as Rational® ClearCase®, which is available from International Business Machines Corporation of Armonk, N.Y. An SCM system, such as ClearCase® can maintain a persistent data repository referred to as a Versioned Object Base (VOB). The VOB can be considered a virtual, mountable volume in the host computer or elsewhere in a computer network. Files, directories, and metadata can be stored within the VOB.

The SCM system can provide a dynamic view connection to the data repository that is always active. This dynamic view can work in combination with a part of the SCM system known as the Multi-Version File System (MVFS). The MVFS works in conjunction with a computer operating system to intercept file level accesses, i.e. reads and writes, to files having locations that can be resolved to the data repository. In one embodiment, the MVFS can record, or create a record, for each access of a file stored in the data repository. These records of file accesses, taken together, form audit information, also referred to as an audit trail.

In step 125, since the audit function has been activated by the listener attached to the build tool, the SCM system can monitor or track accesses to files stored within the data repository. The build tool can perform the processing necessary for completing the build, i.e. compiling, linking, and the like. This processing includes accessing the various software assets needed to complete the functions specified in the buildfile. As noted, these software assets can be included, or stored, within the data repository of the SCM system.

The SCM system can intercept file level system calls relating to the files stored within, or having a location that can be resolved to, the data repository managed by the SCM system. In this manner, the SCM system can determine each of the software assets required and/or generated by the build tool to perform the unit of the build, i.e. the current build process. As noted, for each file read and created that has a location that can be resolved to the data repository, a record can be created by the audit function of the SCM system. The record can indicate the particular file that was accessed, the function that accessed the file, as well as any child process of such a function that also accessed the file.

In step 130, the build tool can complete the build process and generate an event indicating that condition. In step 135, the listener registered to receive such an event can receive the event. Accordingly, in step 140, the listener, responsive to receiving the event indicating that the build process has finished, or otherwise stopped, can notify the audit function and instruct the audit function to stop.

In step 145, the SCM system can generate a BOM corresponding to the unit of the build, or build process, performed by the build tool. The audit information is formed of the records of file accesses performed during the build process. The audit information can include or specify any information necessary to reproduce the build process, whether software assets, commands, parameters, etc. In any case, the SCM system can review the audit information to produce a BOM which indicates those software assets, including which version of such assets, that were used in the course of the build process.

Once a BOM is generated, the BOM can be reviewed and/or processed as any other BOM for a given software system under development. For example, within the SCM system, the BOM can be compared with other BOMs to determine whether any dependencies exist among the various BOMs. These data dependencies can be evaluated and used in making build avoidance decisions.

It should be appreciated that while the event provided to the listener has been described as indicating the start of a build process, any of a variety of different events can be provided to a listener at different points within the build process to initiate an audit function provided that the build tool provides such events. For example, events can be generated responsive to starting and stopping of a task, a target, etc. The configuration of the listeners, and thus the events that will trigger an audit function, can be predetermined. In one embodiment, a plurality of different listener/event configurations can be provided such that a developer can select a desired granularity of the BOM to be generated, i.e. a BOM corresponding to a unit of a build, one or more tasks, one or more targets, etc.

In another embodiment, the listener objects can include code for implementing the audit functions described herein. In such an embodiment, the listener need not call or otherwise invoke an audit function of an SCM tool as the functionality can be self-contained within the listener. For example, the code necessary for performing the audit function can be disposed within a wrapper and included within the listener object.

The present invention can be realized in hardware, software, or a combination of hardware and software. The present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein. The present invention also can be embedded in a computer program product, which comprises all the features enabling the implementation of the methods described herein, and which when loaded in a computer system is able to carry out these methods.

The terms “computer program”, “software”, “application”, variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, a computer program can include, but is not limited to, a subroutine, a function, a procedure, an object method, an object implementation, an executable application, an applet, a servlet, a source code, an object code, a shared library/dynamic load library and/or other sequence of instructions designed for execution on a computer system.

The terms “a” and “an”, as used herein, are defined as one or more than one. The term “plurality”, as used herein, is defined as two or more than two. The term “another”, as used herein, is defined as at least a second or more. The terms “including” and/or “having”, as used herein, are defined as comprising, i.e. open language. The term “coupled”, as used herein, is defined as connected, although not necessarily directly, and not necessarily mechanically, i.e. communicatively linked through a communication channel or pathway or another component or system.

This invention can be embodied in other forms without departing from the spirit or essential attributes thereof. Accordingly, reference should be made to the following claims, rather than to the foregoing specification, as indicating the scope of the invention.

What is claimed is:

1. A method of auditing a build process comprising:
invoking an audit function from a build tool, wherein the audit function is from a software configuration management (SCM) system;
collecting audit information for files having locations resolved to a data repository managed by the SCM system during a build process implemented by the build tool;
terminating the audit function from the build tool; and
generating a bill of materials for the build process according to the audit information.

2. The method of claim 1, further comprising selecting a build tool and attaching at least one listener object to the build tool, wherein the at least one listener object invokes and terminates the audit function, wherein the audit function is part of the SCM system.

3. The method of claim 1, further comprising selecting a build tool and attaching at least one listener object to the build tool, wherein the at least one listener object comprises the audit function.

4. The method of claim 1, wherein collecting audit information further comprises intercepting accesses to files having locations resolved to the data repository.

5. The method of claim 4, wherein collecting audit information further comprises creating a record corresponding to each read and write of a file stored in the data repository while the audit function is engaged.

6. The method of claim 4, wherein collecting audit information further comprises creating a record corresponding to each file created within the data repository while the audit function is engaged.

7. The method of claim 1, wherein invoking an audit function further comprises:
detecting a selected event within the build tool; and
notifying a listener of the build tool of the selected event, wherein the listener responsively invokes the audit function.

8. The method of claim 1, wherein terminating the audit function further comprises:
detecting a selected event within the build tool; and
notifying a listener of the build tool of the selected event, wherein the listener responsively causes the audit function to terminate.

9. A method of auditing a build process comprising:
engaging an audit function of a software configuration management (SCM) system responsive to a request from a listener of the build tool, wherein the build tool implements a build process for a software system;
monitoring accesses to files having a location resolved to a data repository managed by the SCM system while the audit function is engaged;
storing records corresponding to the accesses to the files having a location resolved to the data repository managed by the SCM system; and
disengaging the audit function responsive to a request from a listener of the build tool.

10. The method of claim 9, further comprising generating a bill of materials for the build process according to the audit information.

11. The method of claim 9, wherein monitoring access to files further comprises intercepting read and write operations involving files having a location resolved to the data repository managed by the SCM system.

12. The method of claim 9, wherein monitoring accesses to files further comprises detecting the creation of a file within the data repository.

13. A machine readable storage, having stored thereon a computer program having a plurality of code sections for auditing a build process, the machine readable storage comprising:
code for invoking an audit function from a build tool, wherein the audit function is from a software configuration management (SCM) system;
code for collecting audit information for files having locations resolved to a data repository managed by the SCM system during a build process implemented by the build tool;
code for terminating the audit function from the build tool; and
code for generating a bill of materials for the build process according to the audit information.

14. The machine readable storage of claim 13, further comprising code for selecting a build tool and attaching at least one listener object to the build tool, wherein the at least one listener object invokes and terminates the audit function, wherein the audit function is part of the SCM system.

15. The machine readable storage of claim 13, further comprising code for selecting a build tool and attaching at least one listener object to the build tool, wherein the at least one listener object comprises the audit function.

16. The machine readable storage of claim 13, wherein the code for collecting audit information further comprises code for intercepting accesses to files having locations resolved to the data repository.

17. The machine readable storage of claim 16, wherein the code for collecting audit information further comprises code for creating a record corresponding to each read and write of a file stored in the data repository while the audit function is engaged.

18. The machine readable storage of claim 16, wherein the code for collecting audit information further comprises code for creating a record corresponding to each file created within the data repository while the audit function is engaged.

19. The machine readable storage of claim 13, wherein the code for invoking an audit function further comprises:
code for detecting a selected event within the build tool; and
code for notifying a listener of the build tool of the selected event, wherein the listener responsively invokes the audit function.

20. The machine readable storage of claim 13, wherein the code for terminating the audit function further comprises:
code for detecting a selected event within the build tool; and
code for notifying a listener of the build tool of the selected event, wherein the listener responsively causes the audit function to terminate.
